(19) United States
(12) Patent Application Publication
(10) Pub. No.: US 2013/0206759 A1
(43) Pub. Date: Aug. 15, 2013

(54) PRESSURE RELIEF DEVICE FOR PRESSURE-PROOF ENCAPSULATED HOUSINGS

(71) Applicants: Helmut Würz, Niederhall (DE); Bernd Limbacher, Schwabisch Hall (DE); Wolf Hermann, Ohringen (DE); Julia Hornig, Wendeburg (DE); Detlef Markus, Braunshweig (DE); Uwe Klausmeyer, Braunschweig (DE)

(72) Inventors: Helmut Würz, Niederhall (DE); Bernd Limbacher, Schwabisch Hall (DE); Wolf Hermann, Ohringen (DE); Julia Hornig, Wendeburg (DE); Detlef Markus, Braunshweig (DE); Uwe Klausmeyer, Braunschweig (DE)

(73) Assignee: R. STAHL SCHALTGERATE GMBH, Waldenburg (DE)

(21) Appl. No.: 13/695,221

(22) PCT Filed: May 3, 2011
(86) PCT No.: PCT/EP11/57054

§ 371 Date: Jan. 16, 2013

(30) Foreign Application Priority Data
May 4, 2010 (DE) 10 2010 016 782.7

(51) Int. Cl. A62C 3/00

(52) U.S. Cl. CPC A62C 3/00
USPC 220/88.2

(57) ABSTRACT

A protective housing designed as a pressure proof capsule has a pressure relief valve which comprises a porous body 23 and a pore closure 31 about its perimeter for preventing the transition of a flame about an edge of the porous body. Alternative embodiments of pore closures 31 are disclosed, including a soft metal ring about an edge of the porous body that is depressed, such as by a pressure ring, into a gapless imbedding relation to the porous body. An edge region of the porous body can be modified by jacketing materials such as synthetic materials, metals and the like for creating a form fitting bond with the body of the protective housing.

### FIELD OF THE INVENTION

The invention relates to a pressure relief device for protective housings and more particularly, to a pressure relief device for protective housings effective for the pressure-proof encapsulation of operating means that are capable of forming ignition sources.

### BACKGROUND OF THE INVENTION

Protective housings of the foregoing type are employed to encapsulate electrical operating means that can be used in an environment that poses an explosion hazard. Under certain circumstances, such electrical operating means may act as ignition sources. If explosive gases or gas mixtures have entered the pressure-proof housing, these can detonate or explode. The resultant pressure must not damage or destroy the housing in a manner that flames or hot particles move to the outside. The housing must withstand the occurring maximum explosion pressure.

U.S. Pat. No. 4,180,177 suggests that a window be provided in a pressure-proof encapsulated housing, wherein a plate of foam is provided consisting of stainless steel. This metal foam plate has a considerable pore volume and thus allows uncombusted, as well as combusted, gases to flow out of the housing volume, in which case the metal foam acts, at the same time, as an effective flame arrester due to the cooling effect of the foam.

DE 1170346 also suggests porous metal bodies such as metal wool. Furthermore, ceramic filters and porous sintered iron bodies are mentioned as flame arresters.

In order to effectively prevent flame transmission, each channel leading from the housing interior to the outside must have a narrow gap width and a considerable length. The flame arrester ensures this by appropriate dimensions of the mesh size or the pore size and the pore volume. The conditions regarding the occurring gap width and thus the flame transmission safety must be maintained not only on the filter body itself but also at its transition to the enclosure. This must also be ensured in the event of any increased internal housing pressure that might act on the filter body, such pressure potentially occurring during an explosion or detonation in the housing interior.

### OBJECTS AND SUMMARY OF THE INVENTION

It is an object of the present invention to provide a pressure-proof encapsulation housing having a pressure relief valve arrangement that enhances safety against flame transmission from the housing.

The pressure relief device according to the invention comprises a receiving body with a passage in which a porous body is arranged. This porous body is enclosed on its edge or on a receiving body that may be configured so as to be a separate component or part of the housing wall. The edge comprises the outside circumferential surface as well as the two radially outside edge zones of preferably flat surfaces through which the gases can flow in and out. The edge is already provided with a pore closure when at least one of the aforementioned surfaces comprises closed pores. As a result, it is possible to prevent flame transmissions along the edge of the porous body. Consequently, the edge-side pore closure improves the safety of the pressure relief device against flame transmission.

The porous body, for example, may be a fiber structure. This may be irregularly ordered fibers of metal, for example, said fibers being connected with each other by sintering, for example, so that a stiff, felt-like metal body displaying a large pore volume is formed. The fibers may consist of one uniform metal or of different metals.

However, it is also possible to use wire for producing the porous body. For example, a braided or knit fabric of wire, a single-layer or multi-layer woven fabric of wire, wire screen structures or the like may be used. Preferably, multi-layer woven wire fabric composite plates, for example, consist of flat wire mesh arrangements that are connected to each other. In doing so, the same or different wires having the same or different diameters and material properties may be used in the individual layers as well as in the different layers.

Furthermore, it is possible to provide a configuration of several expanded metal layers or ribbon coil arrangements as the porous body. Furthermore, the porous body may be a sintered metal body that consists of several metal particles bonded to each other by sintering. The metal particles may be metal spheres having uniform or different diameters or may be metal bodies of the same or different metals and having different shapes.

The edge-side pore closure of the body, according to an embodiment of the invention, blocks a flame that has formed inside the housing, for example, in its path into the edge area of the fiber structure. In particular, this edge-side pore closure prevents the flame from bypassing the porous body. Thus, it is also not possible for any flame transmission to occur at the edge of the porous body.

In order to close the pores, the edge of the porous body may be biased against a seating surface provided on the receiving body in order to close the pores of the porous body toward the outside due to a firm abutment of the edge against the seating surface. The firm abutment between the enclosure and the seating surface is preferably achieved by a tensioning arrangement. For example, the seating surface may be conical. In this case, the edge is preferably also such a conical, mechanically machined abutment surface. Mechanical machining may include, for example, machining by grinding/polishing, laser cutting or a similar method of machining that leaves a smooth surface. In this context “smooth” is understood to mean a surface with a roughness height that is at least as great as the maximum pore cross-section of the porous body. Preferably, the roughness of the abutment surface is lower. Due to the resultant gapless seat of the porous body, there no longer exist any gaps larger than those of the porous material between the porous material and the surrounding material, i.e., the seating surface. Consequently, a bypassing of the porous body by hot gases, particles or flames is prevented.

The pore closure has the effect that flames that are being formed remain locked in the housing and cannot exit toward the outside. However, the pressure relief device allows cooled gases to exit and thus minimizes the peak pressure occurring in the housing. The mechanical strength of the protective housing required for pressure-proofing can thus be lowered.

It has been found to be useful to provide means that ensure the gapless joining of the porous body to the receiving body even when the porous body is being slightly moved or deformed, for example, as a result of a load acting on the body. Thus, the body may be mounted on edge-side annular zones or, preferably be firmly clamped in place. Furthermore, it may be advantageous to shape the edge of the porous body in a conical manner so that said body tapers toward the outside—viewed from the housing interior. Explosive pressure occurring in the housing thus effects a tighter abutment of the edge-side abutment surface of the porous body against the seating surface of the receiving body and thus an improved seal at this site.

It is also possible to mount the porous body using an edge enclosure that develops a tension pressure such that the pores of the porous body collapse in the active region of the edge mount, thus, again establishing the pore closure. This is particularly useful in porous bodies of wire.

Furthermore, it has been found to be advantageous to produce the edge-side pore closure of the body with a material that closes the pores, for example, in that it penetrates into the pores at least somewhat. This material may a soft, plastic material such as, for example tin, a synthetic material, for example a thermoplastic or a duroplastic synthetic material, an elastomer or the like. Preferably, this material forms a hoop enclosing the edge of the porous body, said hoop closing the pores, on the one hand, and being seated in a gapless manner in the receiving body, on the other hand. In addition, this hoop may be glued into the receiving body or be secured therein by other sealing means. The material enclosing the edge of the porous body (metal or non-metal) may be considered a seal. Preferably, this seal molds itself in a plastic manner into the edge-side pores of the porous body.

A collar bonded to the receiving body, e.g., by a sealing compound, may be provided on the hoop. In doing so, the seal will be axially at a distance from the porous body. Deformations of the porous body, e.g., due to explosions in the housing interior do not damage the seal, so that edge-side gaplessness remains ensured. In addition, the hoop and the collar separate the applied sealing compound from the porous body so that the penetration of potentially thinly liquid sealing compound into the porous body is avoided.

In addition, a membrane may be provided that seals the passage of the receiving body so as to be gas-permeable but water-impermeable. Additionally or alternatively, a spray guard may be provided.

Other objects and advantages of the invention will become apparent upon reading the following detailed description and upon reference to the drawings, in which:

### BRIEF DESCRIPTION OF THE DRAWINGS

FIG. 1 is a diagrammatic depiction, partially broken away, of an illustrative protective housing having a pressure relief device in accordance with the invention;

FIG. 2 is an enlarged perspective vertical section of the pressure relief device shown in FIG. 1;

FIGS. 3-6 show alternative embodiments of porous structures that can be used in the pressure relief device shown in FIG. 2;

FIG. 7 is a perspective vertical section of a modified embodiment of a pressure relief device in accordance with the invention;

FIG. 8 is an enlarged perspective vertical section of the porous body of the pressure relief device shown in FIG. 7;

FIG. 9 is an enlarged perspective vertical section of the edge of the porous body shown in FIG. 8;

FIG. 10 is a perspective vertical section of another embodiment of a pressure relief device in accordance with the invention;

FIGS. 11 and 12 are enlarged perspective vertical sections of the porous body of the pressure relief device shown in FIG. 10;

FIG. 13 is a perspective vertical section of a further alternative embodiment of a pressure relief device in accordance with the invention;

FIG. 14 is an enlarged perspective vertical section of a further alternative embodiment of the pressure relief device; and

FIG. 15 is a perspective section of a further alternative embodiment of the pressure relief device in accordance with the invention.

While the invention is susceptible of various modifications and alternative constructions, certain illustrative embodiments thereof have been shown in the drawings and will be described below in detail. It should be understood, however, that there is no intention to limit the invention to the specific forms disclosed, but on the contrary, the intention is to cover all modifications, alternative constructions and equivalents falling within the spirit and scope of the invention.

### DETAILED DESCRIPTION OF THE PREFERRED EMBODIMENTS

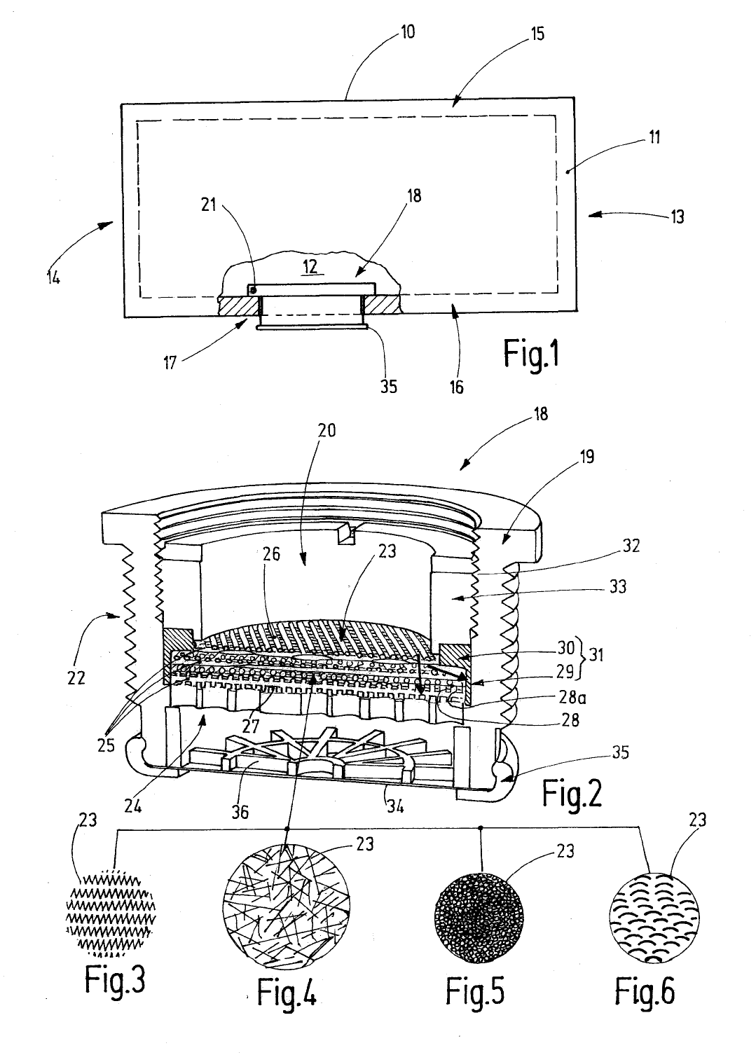

Referring now more particularly to FIG. 1 of the drawings, there is shown an illustrative protective housing 10 in accordance with the invention that can accommodate various types of components, such as for example, electrical installations such as circuit boards, driving devices, electronic or electrical components and the like, which can potentially act as ignition sources during operation or in error in faulty situations. The illustrated protective housing 10 has a pressure-proof wall 11 that defines a tightly enclosed interior 12 of the protective housing 10. The interior 12 is not hermetically sealed with respect to the environment. Consequently, flammable gases may enter the interior 12. However, the wall 11 is tight in so far that no openings or gaps are provided at any point through which a flame transmission could occur.

The wall 11 in this case comprises lateral parts 13, 14, an upper cover 15 and a bottom 16. The lateral parts 13, 14, as well as the upper cover 15 and/or the bottom 16, may have an opening 17 in which a pressure relief device 18 is installed. The opening 17 in this case is in the bottom 16, and the pressure relief device 18 establishes a gas-permeable connection between the interior 12 and the environment which exhibits a low flow resistance for reducing pressure peaks in the event of explosion-like reactions in the interior 12 such that developing gases can flow out rapidly and easily.

A first embodiment of the pressure relief device 18 is depicted in FIG. 2. The pressure relief device 18 comprises a receiving body 19 having a central passage channel 20. As illustrated, the receiving body 19 may be a separate component or, alternatively, also be a part of the housing wall, in all the embodiments. This receiving body is disposed to connect the interior 12 of the protective housing 10 with the environment in a pressure-equalizing manner. The cross-section of the passage channel 20 may have round or polygonal boundaries. In the present example, the cross-section is circular.

The receiving body 19 may be provided with a flange 21 on its upper end. As depicted in FIG. 2, the flange 21 is at the end facing the interior 12 of the protective housing 10 when in use and abuts against the inside of the wall 11, in this case the bottom 16. The outside circumference of the receiving body 19 may be provided with fastening means such as, for example, an external thread 22 effective for fastening the pressure relief device 18 in the opening 17. To accomplish this, the housing wall may be provided with a matching internal thread. Additionally or alternatively, the receiving body 19 can receive a locknut or be provided with other securing or fastening means.

Arranged in the passage channel 20 is a porous body 23 that acts as a flame arrester. In the present exemplary embodiment, the porous body 23 is designed as a flat, disk-shaped body having a circular contour and uniform thickness. In order to support the porous body 23, the receiving body 19 comprises a screen bottom 24 extending transversely through the passage channel 20, said screen bottom being, for example, a stiff one-piece component of the receiving body 19. The screen bottom 24 has a large number of holes that allow gas to pass freely, and the porous body 23 is in contact with the side of the screen bottom 24 that faces the interior 12.

Preferably, the porous body 23 has a tight mesh structure. For example, as shown by FIG. 2, it comprises several superimposed wire grid layers 25. The plurality of grid layers 25 may be arranged loosely on top of each other or be connected with each other. If each grid layer 25 comprises groups of parallel-arranged wires, wherein the wires of one group crosses the wires of the other group and wherein, for example, weld spots are provided at the intersection points. The grid layers 25, among each other, may also be connected by weld spots, solder spots or the like. However, the grid layers 25 may also be a woven wire fabric or a braided wire material, wherein the different grid layers 25 may be connected among each other or be loosely arranged on top of each other.

The porous body 23 has a surface 26 facing the interior 12, a surface 27 located on the screen bottom 24, and an edge 28. The edge comprises 28 an edge surface 28a following the surface of a cylinder jacket, as well as radially outer annular zones of the surfaces 26 and 27. The edge 28 is at least partially enclosed—at least on the outer edge surface 28a—by a cuff 29 of soft metal, for example tin, said cuff additionally transitioning—on least one side of the porous body 23, for example the side 26—into an annular collar 30 that is seated on an outer annular zone of the surface 26. The cuff 29 and the annular collar 30 are soft enough that they abut—under pressure—in a sealing manner at least against the outer annular zone of the surface 26 and thus form a pore closure 31 in the form of a plastic seal.

In order to firmly press the annular collar 30 against the porous body 23, a clamping nut 33 is screwed into the passage 20 by means of an internal thread 32 provided there. The clamping nut 33 in this case has, on its side facing the surface 26, a grove for the accommodation of the annular collar 30. When the clamping nut 33 is tightened, it presses the annular collar 30 in axial direction against the outer edge of the surface 26 and allows the plastic material of the cuff 29 to flow in axial direction and then, optionally, also radially inward, so that the outer pores of the porous body 23 are closed on its edge 28. Any gap that might potentially still exist at this point will be sealed to the extent that no flame transmission bypassing the porous body 23 is possible.

Optionally, the passage 20 may additionally be closed by a membrane 34. For example, this membrane may consist of a material such as used for many types of weather-proof clothing. It may be a breathable polymer film of a block polymer, wherein the polymers alternate, for example, between hydrophilic and hydrophobic sections. The membrane 34 may be secured by a rubber cuff 35 or similar means to the outer fitting of the pressure relief device 18. In addition, the membrane 34 may be supported from the inside by a grid 36.

The pressure relief device 18 described by the foregoing operates as follows:

The pressure relief device 18 screwed into the opening 17 holds the porous body 23 in a gapless bond with the receiving body 19. The porous body 23 creates a pressure relief filter that is enclosed in its edge area by a soft metal ring in this case having the form of the cuff 29. By tightening, i.e., axially tightening, the clamping nut 23 and due to the concomitant deformation of the soft cuff 29, a gapless embedding of the porous body 23 in the receiving body 19 is achieved.

The membrane 24 closes the passage 20 toward the outside to make it water-tight. Preferably, the membrane 34 is breathable and can thus allow gaseous water, i.e. water vapor, present in the interior 12 to escape from the interior 12, thus avoiding an over-humidification of the interior 12.

If an explosion or detonation occurs in the interior 12, this is accompanied by a sudden pressure increase in the interior 12. An outward gas flow that is hardly impaired by the porous body 23 may develop. This may explode the membrane 34 off the pressure relief device 18, tear it open or otherwise open it. The gas stream exiting through the porous body 23 is sufficiently cooled by the body 23 so that no hot particles or flames escape from the pressure relief device 18. Therefore, an ignition of an ignitable gas mixture that might potentially be present outside the protective housing 10 is safely precluded.

Due to the low flow resistance and the relatively large surface of the porous body 23, an excessive pressure increase is prevented in the interior 12. This can be taken into account when the pressure-resistance parameters of the protective housing 10 are determined. Consequently, by installing the pressure relief device 18 in accordance with the invention, the material use and the complexity of the design of the protective housing 10 can be minimized. In addition, it may be possible to design the protective housing 10 for exceptionally low temperatures, at which a larger amount of ignitable gas may enter into the housing and the material used for the construction of the wall 11 may display decreasing mechanical strength due to increasing brittleness.

In the pressure relief device 18 as depicted in FIG. 2, it is possible to insert various suitable approximately disk-shaped porous bodies 23 that are effective to allow a largely unimpaired gas outflow, on the one hand, and thus have narrow gap or pore widths that reliably preclude a flame transmission, on the other hand.

An alternative embodiment of such a body 23 is depicted in FIG. 3, which shows a section of the plan view of such a body. As can be seen, the body 23—in this case—consists of a fabric of a cooling material such as, for example, wire, wire rope, ceramic rope or the like. Several such layers may be connected with each other to form a flexible, or also rigid, body.

Alternatively, it is possible, as is shown in FIG. 4, that the body 23 may be formed by a subordinate arrangement of fibers or filaments that, for example, may consist of a metal or also of other materials such as ceramic or a mixture of different fibers, e.g., also ceramic fibers and metal fibers. FIG. 4 shows a plan view of a sintered metal fiber body that is designed in such a manner that the pores in it have different sizes, however no pore is large enough to permit a flame transmission.

FIG. 5 shows another embodiment of the porous body 23. In this case, the porous body 23 consists of a number of small metal spheres that are bonded to each other and, preferably, are the same size. They also may be bonded to each other by a sintering process.

Alternatively, as is shown in FIG. 6 by a sectional plan view, the molded body 23 may be formed by undulated metal ribbons that are spot-connected to each other, with the metal ribbons being arranged in several layers on top of each other, for example, in order to create the air-permeable body 23. Alternatively, the ribbons formed in the body 23 as in FIG. 6 may also have a width that corresponds to the total height of the body 23, in which case—in that embodiment—advantageously straight passage gaps are formed that offer a particularly low flow resistance.

It will be understood that the above-described embodiment, as well as all the embodiments described hereinafter, may be supplemented with additional details. For example, it is possible to arrange, in the space below the screen bottom 24 or also between the screen bottom 24 and the molded body 23, a molded body or powder. These may adsorb foreign substances from the air. As a result, such foreign substances may be prevented from entering the pores of the body 23 or from entering the housing.

In order to ensure the function of the pressure relief device 18 over the long term, the interior sides of the passage opening 20 may be provided with a coating that continuously releases silver ions. As a result of this, the surfaces are protected against germs and bacteria over an extended time so that no microorganisms that would clog the pores of the filter or the porous body 23 are able to develop. It is also possible to provide the pores of the porous body 23 with a coating that releases silver ions in order to preclude microbial fouling.

Provisions may be made that, following an explosion, the entire pressure relief device 18 or parts thereof such as, for example, the body 23 and/or the membrane 34, are exchanged or replaced. In the simplest case, it is only the rubber cuff 35 or other possible fastening ring and the possibly torn membrane 34 that are removed and replaced by new parts.

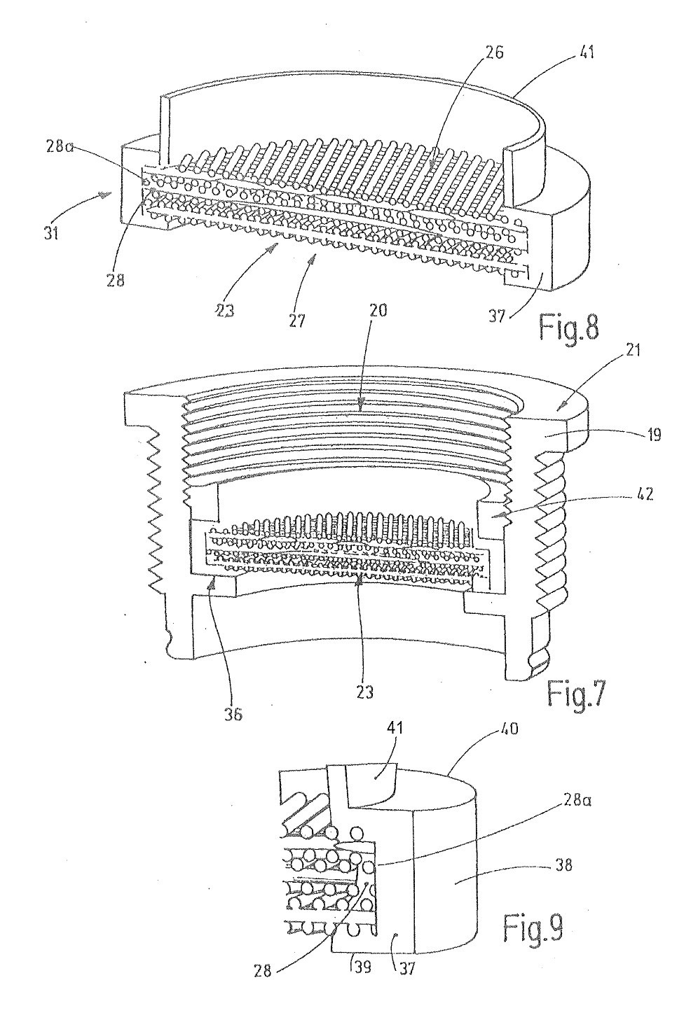

FIG. 7 shows a modified embodiment of the pressure relief device 18, to which the above description applies correspondingly, with the exception of the special features explained hereinafter:

The passage body 19 in this case is designed without a screen bottom, which also is optional in all the embodiments. In place of a screen bottom 24, a plane annular seating surface 36 is provided in the passage channel 20, disposed for accommodating the body 23. The body 23 may be designed in accordance with one of the aforementioned types, and in this case is depicted separately in FIG. 8. As is depicted, its edge 28 is provided with a pore closure 31 that is made, for example, of a synthetic material, or a metal. The material encloses the edge surface 28a, as well as the outer edges of the sides 26, 27, in a gapless manner and penetrates into the outer regions of the pores located there. As is shown in particular in FIG. 9, the thusly formed hoop body 37 has an outside 38 shaped like a cylindrical shell as well as planar annular upper side 40. Extending from the latter may be a tube-shaped axial extension 41 that adjoins the inner edge of the upper side 40. As apparent from FIG. 7, the annular space formed between the wall of the passage channel 20 and axial extension 41 can be filled with the sealing compound 42, said compound ensuring a gapless seat of the body 23 in the passage 20. In addition, the sealing material 42 is prevented from advancing into the porous body 23 and sealing it.

If needed, the clamping nut 33 may additionally be screwed into the passage channel 20 in order to firmly secure the filter body comprising the body 23 and its jacket in the passage 20.

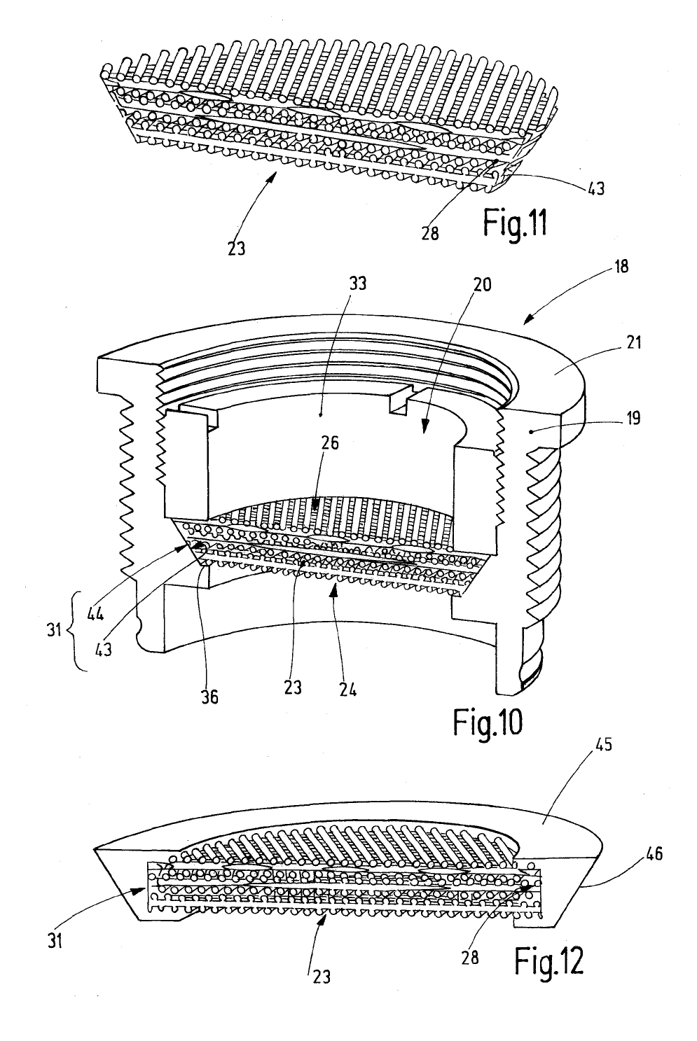

FIGS. 10 and 11 illustrate another embodiment of the pressure relief device 18. The descriptions of the foregoing embodiments correspondingly apply, with the exception of the explanations hereinafter:

The porous body 23 in this case a conical edge surface 28a, instead of a cylindrical edge surface 28a. The edge surface preferably is precision-machined, for example, by grinding, laser cutting or the like, so that a mechanically machined abutment surface 43 is produced. The abutment surface is preferably associated with a similar conical seating surface 44 that is concentrically arranged with respect thereto and adjoins the support surface 36. The annular face surface of the clamping nut 33 pushes against the outer edge of the surface 26 and thus presses the abutment surface 43 against the seating surface 44 in order to achieve a gapless seat of the body 23. Any explosive pressure acting on the surface 26 increases the contact pressure between the abutment surface 43 and the seating surface 44 and thus prevents even an only short-time formation of gaps. Consequently, consistent with the previously described embodiments, the abutment surface 43 and the seating surface 44 together again form the pore closure 31.

As illustrated by FIG. 12, the pore closure 31 may be formed by a hoop-like enclosure of the body 23, in which case this enclosure preferably again consists of a synthetic material, for example a thermoplastic or duroplastic, hardening synthetic material, or also of a soft metal, e.g., tin. The enclosure surrounds the edge 28 of the body 23 and penetrates, at least partially, into the open pores present there in order to close said pores. The resulting enclosure body 45 also may be provided with an exterior conical abutment surface 46 that interfaces without gaps with the seating surface 44 described above. Again, the clamping nut 33 can be used to bias the seat and suppress the formation of gaps.

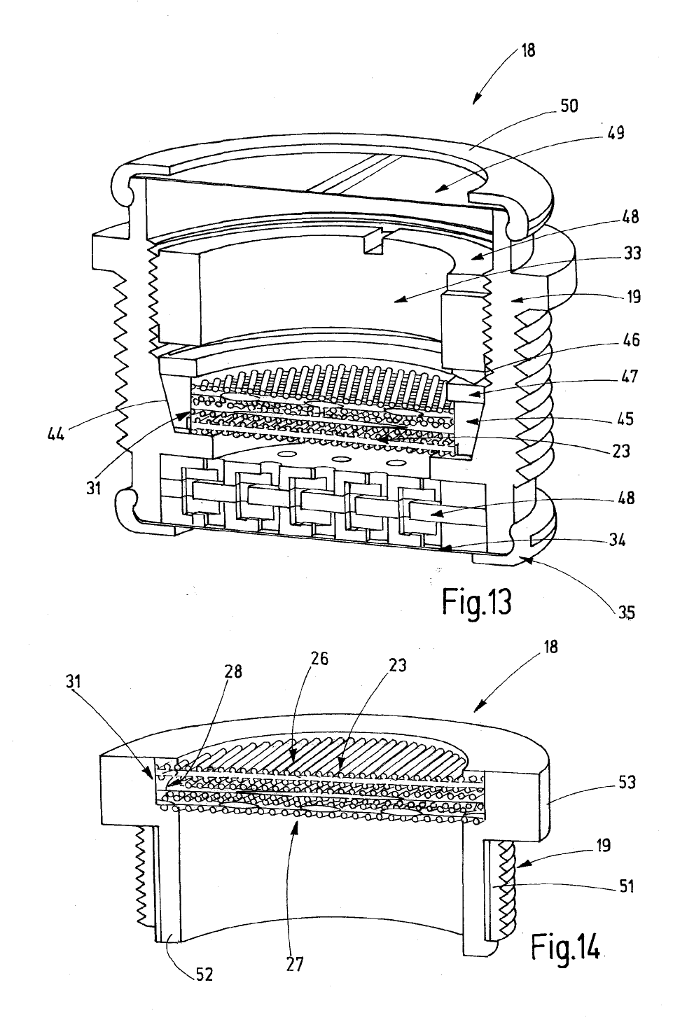

FIG. 13 illustrates another embodiment of the pressure relief device 18 comprising a passage body 19 that may be an adaptation to the embodiment of FIG. 10, for example. In this embodiment, the body 23 as in FIG. 12 may be used. However, it is also possible, as shown, to insert the porous body 23 in an annular enclosure body 45 that, preferably, consists of a soft metal. The cylindrical edge of the body 23 abuts against the cylindrical inside surface of the enclosure body 45, while the outside conical surface of said enclosure body abuts against the conical seating surface of the receiving body 19. However, it is also possible to provide the embodiment of the body 23 as in FIG. 11 or, if there is no conical seating surface 44 but a cylindrical enclosure, any other of the above-described embodiments as the enclosure for the body 23.

In the present case, an axial pressure spring 46 is interposed between the enclosure body 45 and the clamping nut 33 and, optionally a pressure distribution ring 47 is provided. In addition, the clamping nut 33 may be secured in place with a counternut 48. The pressure spring 46 in this instance is in the form of a disk spring. The enclosure body 45 preferably consists of a soft metal, or a synthetic material, or an elastomer.

On the outside of the body 23, a molded element having a plurality of labyrinth-like openings may be provided. The molded body may act as a weatherproof protection. When properly installed, this molded element preferably faces downward.

The previously described membrane 34 with a suitable mounting means, for example in the form of a rubber cuff 35, may provide the lower closure. As, it is possible—as in all of the previously described embodiments—to also provide an extension above the flange 21, with the extension holding another membrane 49, for example, with a cuff 50. The membrane 49 may be designed so as to match the membrane 34. Preferably, it is divided in the middle in order to be able to easily fold up toward the body 23 in case of an explosion. In doing so, the passage channel is cleared when pressure builds up in the housing and cleavage products—e.g., resulting from the combustion of the membrane—are carried by the flame into the pores of the filter, thus clogging the filter. Here, again, a silver ion coating on the inside of the clamping nut 33 and/or other parts, e.g., the body 23, is intended to prevent biological matter from settling and thus prevent a clogging of the pores.

FIG. 14 shows another embodiment of the invention. In this case, the receiving body 19 is reduced to a threaded ring 51. In its central passage, there is seated a tube-shaped extension 52 that is glued or molded into the threaded ring 51. For example, the extension 52 may consist of a polymer, an elastomer or another synthetic material. Above the threaded ring 51, the extension terminates in a flange 53, whose flat annular lower side abuts against the inside of the wall 11 of the protective housing 10 in order to form a gapless seal. The flange 53 consists of a material that is molded around the edge 28 of the body 23, whereby it partially penetrates the pores of the edge 28. Preferably, this material also penetrates into the pores of an outer annular region of the surface 26, 27 of the body 33 thus enclosing said body in a substance-bonded manner while forming the pore closure 31. When pressure relief device 18 is installed in a protective housing 10, it operates consistent with the above description.

If the synthetic material used for producing the extension 52 and the flange 53 is sufficiently strong, there is no need for the threaded ring 51. The thread may be applied outside, directly to the extension 52. In doing so, the extension 52 and the flange 53 form the receiving body that seals the porous body 23, in which case the mentioned pore closure 31 is again provided on the edge 28. Instead of the external thread on the threaded ring 51 or on the flange 52 or on the receiving body 19, it is also possible to use any suitable, sealing fastening means including glued or welded connections.

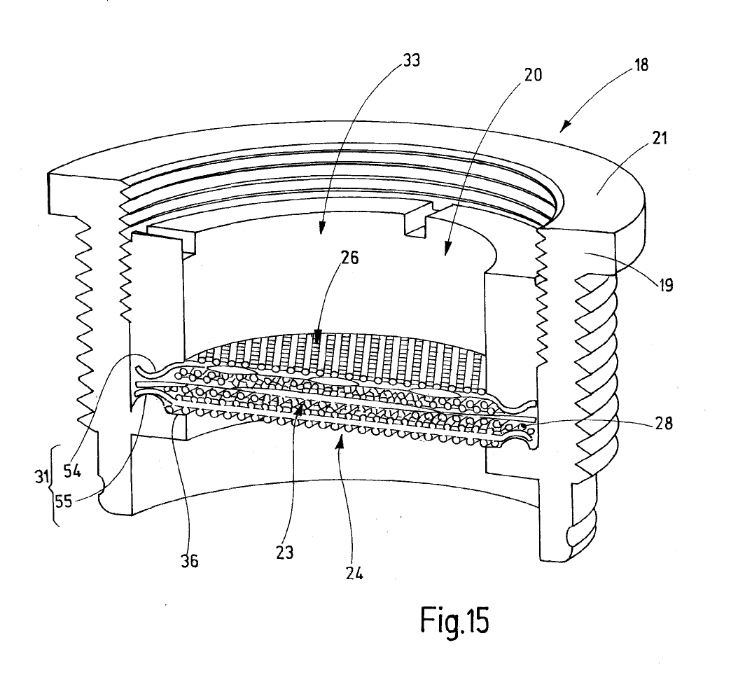

FIG. 15 shows another alternative for achieving the pore closure 31 at the edge 28 of the body 23. The clamping nut 33 is provided with an annular rib 54 on its face facing the body 23 that presses into the outer edge of the surface 26 when the clamping nut 33 is tightened. Likewise, the surface 36 may be provided with a rib 55 that presses into the surface 27 of the body 23 when the clamping nut 33 is tightened. As a result of this, the edge 28 of the body 23, which preferably consists of a wire material, is compressed to such an extent that many of the existing pores collapse. The pore volume at the edge 28 of the body 23 is reduced to such an extent that a pore closure 31 is created. Consequently the ribs 54, 55 form the means to produce the pore closure 31.

From the foregoing, it can be seen that a protective housing designed as a pressure-proof capsule is provided with a pressure relieve device comprising a porous body 23. On its edge, said porous body is provided with a pore closure 31 in order to prevent the transmission of a flame to said edge. The enclosing component represents a receiving body 19 for the pressure-relief device. In conjunction with the receiving body 19, the pore closure forms a gapless bond. For example, the porous—unmachined—body 23 may be enclosed by a soft metal ring along its edge region and, for example, may be pressed through a prespecified conical contour of a receiving body and a pressure ring in such a manner that a gapless embedding is achieved due to the deformation. In addition, the deformation may be maintained lastingly by resilient elements in order to compensate for any heat expansion of the various materials in case of temperature fluctuations. The receiving body 19 may also be formed by the wall 11 itself

Alternatively, the edge region of the body 23 can be modified by jacketing with materials such as synthetic materials, metals, etc., in such a manner that the jacketing, together with the receiving body 19, creates a form-fitting bond with the use of glue or a sealing compound, which bond complying with the Ex-protection requirements.

It will be understood that the use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e. meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Moreover, any combination of the above-described elements in all possible variations thereof is encompassed by the invention unless otherwise indicated herein or otherwise clearly contradicted by context.

1-15. (canceled)

16. A protective housing for encapsulation of operating means that are capable of forming ignition sources comprising:
a housing wall structure that defines an internal compartment having an opening (17),
a pressure relief device (18) disposed within said opening,
said pressure relief device including a body (19) that has a passage (20),
a porous body (23) arranged in the passage (20), said porous body (23) having two exposed surfaces (26,27) facing away from each other and an edge (28), and
a pore closure (31) disposed in close fitting relation to the edge (28) of the porous body (23).

17. The protective housing according to claim 16 in which said body (23) is a metal wire structure with wires arranged in an ordered manner.

18. The protective housing according to claim 16 in which said body (23) is a metal wire structure with wires arranged in an unordered manner.

19. The protective housing according to claim 16 in which said body (23) is a metal fiber structure with fibers arranged in an ordered manner.

20. The protective housing according to claim 16 in which said body (23) is a metal fiber structure with fibers arranged in an unordered manner.

21. The protective housing according to claim 16 in which said body (23) consists of a metal foam.

22. The protective housing according to claim 16 in which said body (23) consists of a sintered metal.

23. The protective housing according to claim 16 in which said edge (28) of said porous body (23) has an abutment surface (43), and said pore closure (31) is defined by a seating surface against which said abutment surface is biased for closing pores in said edge (28).

24. The protective housing according to claim 23 in which said seating surface (44) is conical.

25. The protective housing according to claim 23 in which said seating surface (44) is a planar machined surface.

26. The protective housing according to claim 24 in which said abutment surface (43) has a conical shape complimentary to said seating surface (44).

27. The protective housing according to claim 16 in which said exposed surfaces (26, 27) of said porous body each are firmly clamped about an annular zone within said passage (20).

28. The protective housing according to claim 16 in which said pore closure (31) comprises material that closes pores of said body (23) at the edge (28).

29. The protective housing according to claim 28 in which the material of said porous body (23) includes a soft plastic metal, a synthetic material, a thermoplastic material, a duroplastic material, or an elastomer.

30. The protective housing according to claim 28 in which material of said pore closure (31) extends into pores of the body (23).

31. The protective housing according to claim 28 in which material of the pore closure forms a flange (37, 53).

32. The protective housing according to claim 28 in which material of said pore closure forms a flange (37, 53).

33. The protective housing according to claim 16 including a collar (41, 52) provided on the flange (37, 53) in sealed relation to the body (19, 51).

34. The protective housing according to claim 16 including a gas-permeable, water-permeable membrane (34, 49) in the passage (20 of the body (19).

35. The protective housing according to claim 16 including a spray guard (48) in the passage (20) of the body (19).
